(19) United States
(12) Patent Application Publication
(10) Pub. No.: US 2023/0229787 A1
(43) Pub. Date: Jul. 20, 2023

(54) AUTOMATED ZERO TRUST SECURITY VALIDATION

(71) Applicant: Prancer Enterprise, San Diego, CA (US)

(72) Inventors: Farshid Mahdavipour, Escondido, CA (US); Karthik Ramamoorthy, Little Elm, TX (US)

(21) Appl. No.: 18/186,156

(22) Filed: Mar. 18, 2023

Related U.S. Application Data
(63) Continuation-in-part of application No. 17/388,020, filed on Jul. 29, 2021.

(51) Int. Cl. G06F 21/57; G06F 21/55

(52) U.S. Cl. CPC G06F 21/577; G06F 21/554; G06F 2221/033

(57) ABSTRACT

The present invention discloses a system and method for automated zero trust security validation and report generation, which performs penetration testing and other testing in a zero trust security environment. The disclosed system and method analyses behavior of software applications under multiple contexts such as firewalls, user identifications, and generate validation report. Beneficially, it encapsulates most kind of security scenarios and threats that software applications require, by taking into account various factors.

### CROSS REFERENCE TO RELATED APPLICATIONS

This application is a continuation-in-part application of prior U.S. non-provisional Pat. Application Ser. No. 17/388020, titled AUTOMATED PEN TEST AS A CODE FOR CLOUD and filed on Jul. 29, 2021, which is incorporated herein by reference.

### TECHNICAL FIELD

Various embodiments are directed to systems and methods to perform security testing and validation. More particularly and specifically, the present disclosure relates to the system and methods for automated security testing and validation in zero trust environments.

### BACKGROUND

The identification and correction of security vulnerabilities is a large area of research and investigation in information security. In particular, many resources are expended to protect the data and services that are hosted by cloud services and network-connected information providers. Various approaches are currently used to identify security vulnerabilities and issues in network-accessible software applications and services.

One such framework of security is Zero Trust. It is a strategic approach to cybersecurity that secures an organization by eliminating the inherent trust and continuously validating every stage of a digital interaction. The framework is based on the principle of “never trust, always verify.” It is designed to protect modern environments and enable digital transformation. Currently, the age of VPNs is fading away, and more enterprise applications are now becoming visible to the internet. This necessitates strong zero-trust protocols to protect your data from malicious online actors. Without these measures in place, business’s sensitive information could be left exposed on the web. To provide adequate protection for this data at scale, there is a need for a reliable tool capable of continuous monitoring plus contextual validation for all zero-trust policies that are implemented.

Currently, the existing security assessment and testing tools on the market are inadequate when examining applications developed with a Zero Trust framework. Further, there do not exist automated zero trust security testing applications.

Moreover, many processes are carried out to validate zero-trust application security depending on the context. The applications authenticating is not static and it can assume a vast array of roles and identities depending on user contexts such as identity, network location, session tokens, etc.

To ensure the protection of applications, it is essential to rethink how users access them and how they interact with each other. In lieu of a static perspective, security professionals must consider what actions are permissible from the applications in question. Furthermore, assigning a behaviour-based security identity that designates privileges should be considered as well.

When it comes to modern security instruments, the existing tools cannot be effective for zero-trust applications. If we were to validate a company’s zero trust application with the present resources available in the zero trust model, that would be quite difficult due to its reliance on authentication and authorization of every user, device, and program without using static methods such as IP address or long-lasting API keys/usernames and passwords.

In light of the above-mentioned shortcomings associated with existing testing methods and systems for zero trust applications, it is highly desirable to have a system which help users to automatically configure and perform zero trust security testing and validation.

### SUMMARY

Embodiments of the present disclosure present technological improvements as solutions to one or more of the above-mentioned technical problems recognized by the inventor in conventional systems.

The present invention discloses a system and method for automated zero trust security validation and report generation, comprising a processor communicably coupled a memory device, wherein the processor is configured to receive a configuration file for the penetration testing, analyse behaviour of one or more applications under multiple contexts such as firewalls, user identifications etc. and generate a validation report based on the analysis of the behaviour of one or more applications. In a preferred embodiment of the present invention, the processor is further configured to receive inputs from the users pertaining to the penetration testing, extract metadata from a cloud on which the penetration testing is to be done, based on the metadata, identify all the required information such as the network, APIs used, authentication factors, etc., and generate the configuration file for penetration testing.

Additionally, in a primary aspect of the present invention, the configuration file generated by the system and methods for penetration testing is a software code which emulate one or more threats as software code thereby stimulating one or more automated or controlled attacks in a zero trust environment.

In another embodiment of the same invention, the validation report generated by the system and methods comprises various vulnerability assessments and also recommendations for changes within the applications so that the applications are compliant with zero trust environment.

People, services, and devices all have distinctive identities that can be recognized in various networks and applications. To guarantee data security across these platforms, an advanced Zero Trust testing system disclosed which is customizable enough to handle many contexts and contracts for authorization or denial of records. The disclosed system and method work continuously and contextually to verify the zero-trust controls with precision.

In another aspect, the same disclosure teaches a method for automated zero trust security validation and report generation, the method comprising a plurality of electronic operations executed by a processor and a memory, the plurality of electronic operations including receiving a configuration file for the penetration testing, analysing behaviour of one or more applications under multiple contexts such as firewalls, user identifications etc. and generating a validation report based on the analysis of the behaviour of one or more applications.

Beneficially, the present invention provides a system and method for automated penetration testing in a zero trust environment eliminating user inputs and/or interactions based on automatically generated configuration file which encapsulates most kind of security scenarios and threats, taking into account various factors. Further, the present disclosure is compatible with any type of cloud environments and software applications.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

While the systems and methods are illustrated by use of a computer device embodiments and applications, they are equally applicable to virtually any personal computer or portable or mobile communication device, including for example, a desktop computer, laptop computers, tablet, and virtual reality headset.

### BREIF DESCRIPTION OF DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of the system automated zero trust security validation and report generation, in accordance with an embodiment of the present disclosure;

FIG. 2 is an illustration of steps and methods for automated zero trust security validation and report generation, in accordance with an embodiment of the present disclosure.

In the accompanying drawings, an underlined number is employed to represent a material over which the underlined number is positioned or a material to which the underlined number is adjacent. A non-underlined number relates to a material identified by a line linking the non-underlined number to the material. When a number is non-underlined and accompanied by an associated arrow, the nonunderlined number is used to identify a general material at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present invention discloses a system and method for automated zero trust security validation and report generation. Disclosed system and methods enables a complete testing of applications, clouds, networks, etc., in a zero trust framework or environment and generates a report recommending where all changes are needed and also the scores as against various parameters. This is done using a generated configuration file for penetration testing, which automatically identifies various parameters for testing and basically imitates various possible threats for the applications, network and cloud. Additionally, the system and methods performs the testing based on the configuration file and various contexts in a zero trust environment or framework and generates a validation report, highlighting network security risks, if any.

In a primary embodiment of the present invention, the system for automated zero trust security validation and report generation, comprises a processor;
a memory containing executable non-transitory machine-readable instructions configured to instruct the processor to receive, a configuration file for the penetration testing; analyse behaviour of one or more applications under one or more contexts wherein the one or more contexts is one or more of a context-driven firewall, a static-keyless user authentication, one or more data perimeters, a trusted signing and a scanning of one or more software libraries and vulnerabilities, a certificate based service to service connectivity to automate security assessment, and a token based service to service connectivity to automate security assessment; and generate a validation report based on the analysis of the behaviour of one or more applications.

Further, the processor is configured to generate the configuration file for the penetration testing by receive, from the user, one or more inputs pertaining to a target cloud environment for penetration testing; extract a cloud metadata pertaining to the target cloud environment; identify, based on the extracted cloud metadata, at least one or more networks, one or more APIs, one or more services and one or more authentication factors corresponding to the target cloud environment, remotely; receive, from the user, one or more inputs pertaining to a type of connection to be used; receive, from the user, one or more inputs pertaining to a type of penetration testing to be done; receive, from the user, one or more inputs pertaining to a service for which penetration testing to be done; and generate the configuration file for the penetration testing.

Moving to a zero-trust security model for end-users may imply stricter environmental regulations with which to work. It’s essential to understand that there is no single product or quick procedure an organization can use to be transformed into the desired state of “zero trust”. Every implementation varies based on individual and organizational needs. In other words, it must be tailored according to the corporate objectives and standards in order for you to experience its full benefits. Contextual access policies, such as client certificates/MTLS and OAuth access tokens, are essential for apps to regulate the data they allow. Current agent-based DAST scans, which are conducted with predetermined contexts, can only detect a finite number of risks and threats when testing an application built to embrace the zero trust model on a large scale. Along with that, if zero trust is validated, then the validation would focus on these critical pillars, which are an Identity-driven firewall, passwordless/static-keyless user authentication, data perimeters, the trusted signing and scanning of the software libraries and vulnerabilities, certificate-based / token based service to service connectivity, automated security assessment, and federated identities for hybrid connectivity. Thus, whenever an organisation moves to zero trust environment, it needs to be tested and continuously monitored. An automated zero trust security validation and report generation is disclosed which is capable of continuously monitoring the environment and generate reports based on the identified risks and vulnerabilities and even recommend possible changes that needs to be implemented.

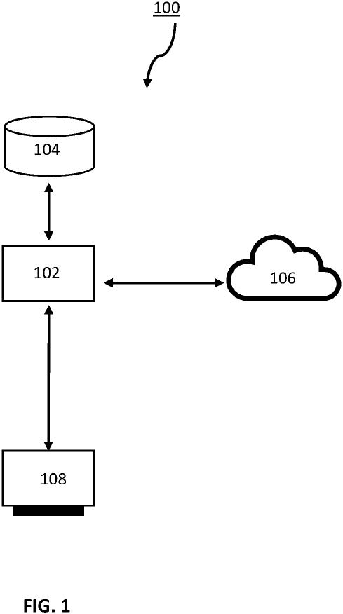

FIG. 1 is a schematic illustration of an exemplary embodiment of the automated penetration testing system for a cloud 100, wherein the system comprises a processor 102 communicably coupled via a communication network with a memory device 104, an application for testing 106 and a graphical user interface 108.

The processor 102 is the core and soul of the system and the memory device 104 contains executable non-transitory machine-readable instructions configured to instruct the processor 102 to receive from a user via the graphical user interface 108, one or more inputs pertaining to the applications and environment for testing. The processor 102 receivers a configuration file for penetration testing from the memory device 104. The processor 102 is further configured to analyse behaviour of one or more applications under one or more contexts wherein the one or more contexts is one or more of a context-driven firewall, a static-keyless user authentication, one or more data perimeters, a trusted signing and a scanning of one or more software libraries and vulnerabilities, a certificate based service to service connectivity to automate security assessment, and a token based service to service connectivity to automate security assessment. Further, the processor 102 is configured to generate a validation report based on the analysis of the behaviour of one or more applications. The said validation report is displayed using the graphical user interface 108.

In a primary embodiment of the present invention, the system and method enables a processor to remotely extract metadata from the cloud on which the penetration test is to be done and remotely identify at least one or more networks, one or more APIs, one or more services and one or more authentication factors corresponding to the target cloud environment using the extracted cloud metadata. The system and method further enables the processor to receive inputs from the user via a graphical user interface, wherein the inputs are basic information needed for penetration testing including but not limited to network configuration, security authentication, the service, the type of penetration testing. This information and the extracted meta data is used by the systems and methods to generate a configuration file, automatically.

In one of the embodiments of the present disclosure, the validation report comprises one or more vulnerability assessments of the one or more applications in a zero trust environment. Further, the validation report comprises one or more portions within the one or more applications where one or more changes are required so that the one or more applications are compliant with the zero trust environment.

Further, disclosed system is operable to test different scenarios in a zero threat environment for software applications, mobile applications, different types of networks, different cloud environments among other things.

One or more components of the invention are described as unit for the understanding of the specification. For example, a unit may include self-contained component in a hardware circuit comprising of logical gate, semiconductor device, integrated circuits or any other discrete component. The unit may also be a part of any software programme executed by any hardware entity for example processor. The implementation of unit as a software programme may include a set of logical instructions to be executed by a processor or any other hardware entity.

Additional or less units can be included without deviating from the novel art of this disclosure. In addition, each unit can include any number and combination of sub-units, and systems, implemented with any combination of hardware and/or software units.

Method steps of the invention may be performed by a processor 102 or a combination or one or more processors executing a program tangibly embodied on a computer-readable medium to perform functions of the invention by operating on input and generating output. Suitable processors include, by way of example, both general and special purpose microprocessors. Generally, the processor receives (reads) instructions and data from the memory device 110 (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; CD-ROMs; USB Drives; Cloud. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk.

Throughout the disclosure, the graphical user interface 108 refers to any and all types of display devices including but not limited to a graphical user interfaces part of other devices, such as a computer, a laptop, a mobile phone or any other similar devices. Alternatively, the graphical user interface may be replaced by any other type of input devices, to read and/or detect an input from the user and send the same to the processor 102.

In various embodiments of the present invention, the processor 102 is configured to receive, from the user, one or more inputs pertaining to a target cloud environment for a penetration testing via the graphical user interface 108. The target cloud is one or more of Azure Cloud, Amazon Web Services, Google Cloud Platform. Without limiting the scope of the invention, the disclosed system and method is compatible with and works efficiently for any type of cloud and cloud environment.

Each cloud has an associated metadata. In another embodiment of the present invention, the processor 102 is configured to extract the metadata pertaining to the target cloud environment. Further, the processor is configured to identify at least one or more networks, one or more APIs, one or more services and one or more authentication factors corresponding to the target cloud environment, from the cloud metadata remotely. Throughout this disclosure, the terms APIs, network, services relates to standard terminologies used in the software industry and are to be interpreted as the same.

In another embodiment of the present disclosure, the processor 102 is configured to receive, from the user via the graphical user interface 108, one or more inputs pertaining to a type of connection to be used. As an illustration, without limiting the scope of the invention, the type of connection to be used is one or more existing connection or one or more new connection. Based on the said input from the user, the processor 102 chooses an existing connection or a new connection. In case the user opts for a new connection, the processor 102 creates a new connection to be used for penetration testing.

In another embodiment of the same disclosure, the processor 102 is configured to receive, from the user via the graphical user interface 108, one or more inputs pertaining to a type of the penetration testing to be done. The type of penetration testing is either an external testing, also called as black box testing, or an internal testing, also called as grey box testing. Without limiting the scope of the invention, the system and methods are capable of performing other types of testing as well and the processor automatically generates the corresponding configuration file for the same.

In another embodiment of the present invention, the processor 102 is configured to receive, from the user via the graphical user interface 108, one or more inputs pertaining to a service for which the penetration testing to be done. The services relates to the type of cloud and the applications to be tested. A user can select the type of services or optionally, enter the service the user desires to be tested.

In an alternate embodiment of the same invention, the processor 102 is configured to receive, from the user via the graphical user interface 108, other inputs from the user for penetration testing, such as one or more authentication credentials from a key vault, one or more subnets to deploy the penetration test.

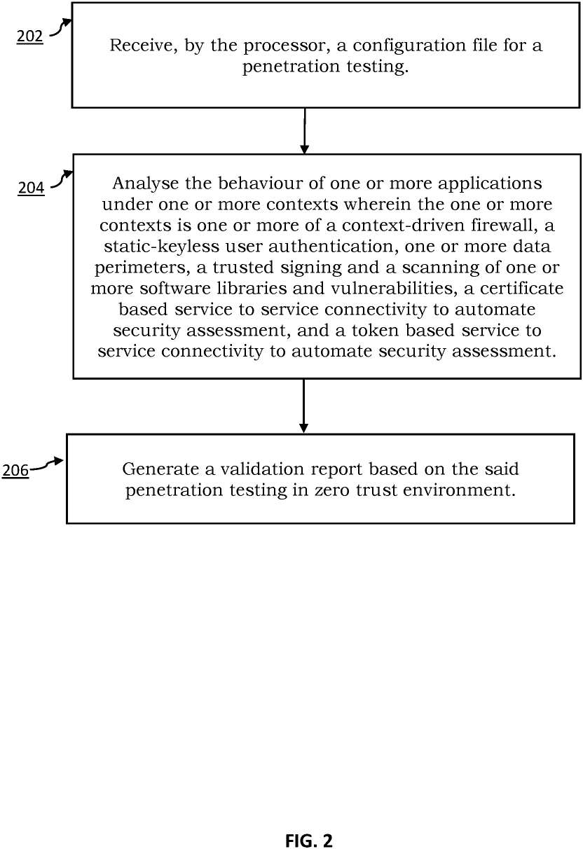

FIG. 2 depicts a preferred embodiment of a method for automated zero trust security validation and report generation, with the various units in operation. The method comprises method steps being executed by a being executed by a processor 102 communicably coupled via a communication network with a memory 104, an application 106 for penetration testing and a graphical user interface 108, using a non-transitory computer readable medium including program code, wherein upon execution the program code executes in an environment of computer systems providing method for automated zero trust security validation and report generation. At a step 202, the processor receives a configuration file for the penetration testing. At a step 204, the processor analyses the behaviour of one or more applications under one or more contexts wherein the one or more contexts is one or more of a context-driven firewall, a static-keyless user authentication, one or more data perimeters, a trusted signing and a scanning of one or more software libraries and vulnerabilities, a certificate based service to service connectivity to automate security assessment, and a token based service to service connectivity to automate security assessment. At a step 206, the processor generates a validation report based on the analysis of the behaviour of one or more applications.

The disclosed method also comprises method steps of generating a configuration file for penetration testing, comprising method steps of receiving one or more inputs from a user pertaining to a target cloud environment for penetration testing; extracting a cloud metadata pertaining to the target cloud environment; identifying at least one or more networks, one or more APIs, one or more services, one or more authentication factors corresponding to the target cloud environment using the extracted cloud metadata, remotely;
receiving one or more inputs from the user pertaining to a type of connection to be used; receiving one or more inputs from the user pertaining to a type of penetration testing to be done; receiving one or more inputs from the user pertaining to a service for which penetration testing to be done; and generating the configuration file for the penetration testing, by the processor.

In a preferable embodiment of the present disclosure, the generated configuration file is a software code, configurable within the one or more applications. Further, configuration file can be edited/altered by the user as well to incorporate any desired changes. This provides dynamic testing capabilities. The processor is further configured to perform the penetration testing based on the generated configuration file, remotely, without pen-testers in a zero trust environment. The processor performs penetration testing of the target applications, networks, and cloud environments, considering multiple threats, scenarios and factors.

In another preferred embodiment of the same invention, the processor is further configured to generate a validation report based on the performed testing in a zero trust environment. The findings of the generated penetration testing report identifies the network and security risks, potential vulnerabilities and attacks and other issues in the applications including the cloud. The user may go through the identified risks and can mitigate the same. Beneficially, the report is generated automatically, with minimum intervention from the user and without any pentesters and that too in a zero trust environment. This makes it technologically advanced than the existing systems and much more reliable.

Beneficially, it overcomes the current problem of automated tool for doing the zero trust validation. Almost all the time, when enterprises and businesses want to validate their zero trust implementation, they have to use different set of tools and lots of manual work to cover various test cases. Further, due to nature of the zero trust implementation, it is not possible to test all aspects of implementation with manual verification. Contextual access policies like workload identities, client certificates / MTLS, or O-Auth tokens are crucial for applications to determine data access. Also, agent-based Dynamic Application Security Testing ( DAST) scans which utilize fixed contexts may not be able to locate all potential attack scenarios when testing zero-trust applications at scale. However, using ht esystema nd method steps disclosed in the present invention, during the security testing and assessment, the concentration is on zero-trust applications and critical control pillars such as identity-driven, behavior-driven, or context-driven firewalls with custom code. Additionally, data perimeters to verify access to information and password less/static keyless user authentication are also crucial components in evaluating zero-trust applications. In addition to these core elements when assessing security measures for a zero-trust environment, several other important considerations must be taken into account which the disclosed system and method takes into account.

Zero trust validation analyzes application behavior under different contexts to verify if it is only performing appropriate functions and only interacting with the needed binaries and data sources. Based on its findings, a library of behavioral parameters is created for each application to establish security testing scenarios automatically. Typically, applications have their own trusted fingerprint, and permissions can be limited to what is needed for the application to function (untrusted). Any type of attack will go beyond normal behavior and trigger an alarm or log out of the application to block any unauthorized activity or access to restricted resources. Expanding zero trust to application environments demonstrates to be somewhat more complex than applying it to the network. Applications and their workloads are more varied, dynamic, and complex than networks as they perform numerous diverse capacities and have conditions on information sources and possibly other applications.

The methodology for automated Zero Trust testing is to explore and catalog all apps, track their behavior over time to provide the basis for allowed and expected activities, and eliminate all security risks identified through behavioral profiling (i.e., unnecessary permissions, excessive permissions, risky dependencies, etc.), create security policies that enforce a distrust posture for application activity so that only authorized behavior is allowed, and send alerts to checkpoints when a policy is violated so that corrective action can be triggered to fix the threat. Thus this automated zero trust validation helps to fully protect our enterprise from risks that occur in networks, data, identities, and applications and reduce the attack severity.

The disclosed system and method teaches a framework which instinctively delivers threat as code and permits users to emulate automated/ controlled attacks employing a managed service and gives straightforward interfaces for joining bespoke pentesting scripts to recreate a wide extent of assault sorts, counting white-box, black-box, in-network, and out-of-network testing. Further, the automated discovery provides coverage for user’s framework, APIs, and Web Apps by combining an uncommon low-code and no-code methodology. Moreover, the present invention also provides continuous and relevant approval of users’ zero trust controls at scale, so that their information, data and applications are secure.

The disclosed automated zero trust security testing and report generation system and methos, without limitation, validates the effectiveness of the below controls with the adversary techniques:
Identity-driven or behavior-driven, or context-driven firewall -Automated testing with unauthorized identities on both internal and external networks
Passwordless/static-keyless user authentication - Automated token spoofing and DDOS of user authentication APIs
Data perimeters - Exfiltrate data from customer networks to non-customer-owned cloud buckets or SAAS platforms
The trusted signing and scanning of the software libraries and vulnerabilities - Testing zero-day vulnerabilities on selected OSS dependencies used in the application stack.
Certificate-based / token based service to service connectivity - Testing lateral movements in large-scale microservices based environments
Automated security assessment - Continuous real-time security validation
hybrid or multi-cloud connectivity - Validate authentication security between various trust boundaries within the cloud, on-prem, and SaaS applications.

Beneficially, the disclosed systems and methods help reduce the attack vectors and misconfigurations for vital zero-trust apps so that we can decrease the scope of vulnerabilities and protect sensitive data from being breached. Moreover, this framework for automated testing and validation in zero trust environment aggressively validates users’ zero-trust cloud, application and network security measures against real-world attacks to harden, improve and protect their cloud ecosystem continuously.

For illustration purpose, as an example, the findings of an automated zero trust testing would generate a report highlighting issues related to the identity-driven firewall for a cloud platform, or that the application needs to enable token-based service-to-service connectivity, etc. The findings in the report also comprise its severity level and their ratings, and include the specific path or area within the application or within the cloud environment as to where exactly to integrate the changes so that the application and cloud environment would be in compliance with the zero trust model or environment. Furthermore, the generated report may also display different test cases and various “zero trust policies” for every application, network and cloud platforms tested and as well as how to resolve any issues present such that they are in compliance with the zero trust model.

In another alternate embodiment of the same disclosure, the system and method are integrated with Artificial intelligence and machine learning, wherein the processor learns the different systems and apply algorithms to identify the potential risks associated with it. False positives results are then fed back to improve the algorithm and thereby the system and method becomes efficient with every use.

In an alternative embodiment of the same invention, the said invention is integrated with a distributed ledger based platform such as a blockchain, as an alternative to the memory device. In this embodiment, the distributed ledger based platform is operable to store at least the user inputs, a threat metadata and the instructions to be executed by the processor and also the generated penetration test report. Further, the system and method may also be configured in such a manner so as to enable the system to be working automatically using smart contracts, on predefined regular intervals. With the inherent nature of security integrated within a distributed ledger based platform, it makes the system and method more robust and secure. Furthermore, the system and method may also be configured to accept one or more types of cryptocurrency as payments to operate the system.

Various embodiments of the present invention may also be implemented at different environments where cloud and network are being used. Alternatively, the system and method may be modified to perform penetration testing in other networks, applications, services, and software as well.

It shall be further appreciated by the person skilled in the art that the terms “first”, “second” and the like herein do not denote any specific role or order or importance, but rather are used to distinguish one party from another.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for materials, components or elements not explicitly described also to be present. Reference to the singular is also to be construed to relate to the plural.

Although an exemplary embodiment of at least one of a system and a method has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the data sent or received by any of the modules may be sent or received directly and/or via one or more of the other modules.

One skilled in the art will appreciate that a “system” could be embodied as a processor, a computer device integrated in a vehicle, a personal computer, a server, a console, a personal digital assistant (PDA), a tablet computing device, a smartphone, a virtual reality headset, or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. At least portions of the functionalities or processes described herein can be implemented in suitable computer-executable instructions. It will be appreciated that features of the present disclosure are susceptible to being combined in various combinations and additional features may be introduced without departing from the scope of the present disclosure.

1. A system for automated zero trust security validation and report generation, the system comprising:
a processor;
a memory containing executable non-transitory machine-readable instructions configured to instruct the processor to:
receive, a configuration file for a penetration testing;
analyse behaviour of one or more applications under one or more contexts wherein the one or more contexts is one or more of a context-driven firewall, a static-keyless user authentication, one or more data perimeters, a trusted signing and a scanning of one or more software libraries and vulnerabilities, a certificate based service to service connectivity to automate security assessment, and a token based service to service connectivity to automate security assessment; and
generate a validation report based on the analysis of the behavior of one or more applications.

2. The System of claim 1 wherein the processor is configured to:
receive, from the user, one or more inputs pertaining to a target cloud environment for the penetration testing;
extract a cloud metadata pertaining to the target cloud environment;
identify, based on the extracted cloud metadata, at least one or more networks, one or more APIs, one or more services and one or more authentication factors corresponding to the target cloud environment, remotely;
receive, from the user, one or more inputs pertaining to a type of connection to be used;
receive, from the user, one or more inputs pertaining to a type of penetration testing to be done;
receive, from the user, one or more inputs pertaining to a service for which penetration testing to be done; and
generate the configuration file for the penetration testing.

3. The System of claim 1 wherein the validation report comprises one or more vulnerability assessments of the one or more applications in a zero trust environment.

4. The System of claim 1 wherein the validation report comprises one or more portions within the one or more applications where one or more changes are required so that the one or more applications are compliant with the zero trust environment.

5. The System of claim 1 wherein the configuration file for penetration testing is a software code which emulate one or more threats as software code thereby stimulating one or more automated or controlled attacks.

6. The System of claim 1 wherein the one or more applications is a cloud environment.

7. The system of claim 1 wherein the one or more applications are software applications.

8. The system of claim 1 wherein the validation report is displayed using a graphical user interface.

9. A method for automated zero trust security validation and report generation, the method comprising a plurality of electronic operations executed by a processor and a memory, the plurality of electronic operations including:
receiving, a configuration file for a penetration testing;
analysing behaviour of one or more applications under one or more contexts wherein the one or more contexts is one or more of a context-driven firewall, a static-keyless user authentication, one or more data perimeters, a trusted signing and a scanning of one or more software libraries and vulnerabilities, a certificate based service to service connectivity to automate security assessment, and a token based service to service connectivity to automate security assessment; and
generating a validation report based on the analysis of the behaviour of one or more applications.

10. The method of claim 9 comprising
receiving one or more inputs from a user pertaining to a target cloud environment for the penetration testing;
extracting a cloud metadata pertaining to the target cloud environment;
identifying at least one or more networks, one or more APIs, one or more services, one or more authentication factors corresponding to the target cloud environment using the extracted cloud metadata, remotely;
receiving one or more inputs from the user pertaining to a type of connection to be used;
receiving one or more inputs from the user pertaining to a type of penetration testing to be done;
receiving one or more inputs from the user pertaining to a service for which penetration testing to be done; and
generating the configuration file for the penetration testing.

11. The method of claim 9 wherein the validation report comprising one or more vulnerability assessments of the one or more applications in a zero trust environment.

12. The method of claim 9 wherein the validation report comprising one or more portions within the one or more applications where one or more changes are required so that the one or more applications are compliant with the zero trust environment.

13. The method of claim 9 wherein the configuration file for penetration testing is a software code which emulate one or more threats as software code thereby stimulating one or more automated or controlled attacks.

14. The method of claim 9 wherein the one or more applications is a cloud environment.

15. The method of claim 9 wherein the one or more applications are software applications.

16. The method of claim 1 wherein the validation report is displayed using a graphical user interface.
